(19) United States
(12) Patent Application Publication
(10) Pub. No.: US 2006/0172081 A1
(43) Pub. Date: Aug. 3, 2006

(54) Apparatus and method for plasma treating and dispensing an adhesive/sealant onto a part

(76) Inventors: Patrick Flinn, Avon Lake, OH (US); Kevin Stump, Wellington, OH (US); James S. Tyler, Galt, CA (US)

Correspondence Address: WOOD, HERRON & EVANS, LLP (NORDSON), 2700 CAREW TOWER, 441 VINE STREET, CINCINNATI, OH, 45202, US

(21) Appl. No.: 11/049,263

(22) Filed: Feb. 2, 2005

(51) Int. Cl. B05D 3/00; B05B 3/00; B05B 13/02

(52) U.S. Cl. 427/532; 118/305; 118/323

(57) ABSTRACT

An apparatus that includes a plasma treatment device operable to produce a plasma treated surface on a part and a dispensing module and operable to dispense an adhesive/sealant onto the plasma treated surface.

### FIELD OF THE INVENTION

The present invention relates generally to vehicle assembly and, more particularly, to an apparatus and method for preparing a part for assembly onto a vehicle.

### BACKGROUND OF THE INVENTION

Adhesive, bonding and sealing agents are ever increasingly used in manufacturing environments. However, prior to using such agents it is necessary to clean the surface of the part to which the agent is to be applied. In different manufacturing environments, such a cleaning process is also referred to as preparing, treating or priming the surface. In one application, a number of operations are required to prepare a fixed glass, for example, a windshield, rear window, etc., for assembly into an associated body flange of a vehicle.

With respect to the windshield, glass manufacturers supply automobile windshields with a “blackened area”, i.e., an area of predetermined width along the marginal edge of the windshield which is covered with a black, ceramic frit having a roughened surface. It is the responsibility of the automotive manufacturer to prepare this blackened area for assembly to the body flange of the vehicle. First, a clear glass primer material is applied to the blackened area, which cleans and etches the blackened area to create a bonding site. Then, a black glass primer is applied over the bonding site, which provides a longer term protection from ultraviolet light. It is known to apply those glass primers manually and automatically. In one automated process, a glass primer is applied with a wet brush by a robot or other automated brush mover. Thereafter, a felt wick is dragged by the robot immediately behind the wet brush to wipe dry the glass primer and force it into the roughened surface of the blackened area.

In another automated process, a pair of dispensing heads, one for each primer, are mounted on a robot arm or other positioning device. A continuous web or application strip is positioned immediately below the dispensing heads. In applying the clear glass primer, the dispensing heads are moved in a first direction around the windshield perimeter; and the clear glass primer is dispensed into the web, which spreads the clear glass primer onto the windshield. Next, the web is incremented to place unused material under the black primer dispensing head. The dispensing heads are then moved in an opposite direction around the windshield perimeter; and the black glass primer is dispensed into the web, which spreads the black glass primer onto the windshield. The web is incremented to place unused material under the clear primer dispensing head, and the process is repeated for the next windshield. Automated systems for applying such primers are described in U.S. Pat. Nos. 6,695,917, 5,370,905, 5,277,927 and 4,857,367, which patents are issued to the assignee of the present invention and are hereby incorporated in their entirety by reference herein.

In the above and other applications, such primers often require special handling, which means assembly line workstations with specially built enclosures and ventilation are required. Further, the disposal of such primers is time consuming and expensive. In addition, with known systems, a first assembly line workstation is required to apply the primers to the windshield, and a downstream, second workstation is necessary to dispense an adhesive/sealant onto the windshield prior to installation.

Therefore, there is a need to reduce or eliminate the use of primers and other chemicals requiring special handling in a manufacturing environment as well as to simplify the part preparation process to reduce the cost and time required to prepare a part such as fixed glass for installation.

### SUMMARY OF THE INVENTION

The present invention provides an apparatus and process for preparing a part for assembly in a vehicle in which the use of chemicals to prime the part is eliminated. The apparatus and process of the present invention cleans or prepares the part and substantially simultaneously applies an adhesive/sealing agent in a single pass around the part at a single assembly line workstation. Thus, the apparatus and process of the present invention prepares a part for installation in minimal time and at less cost than known processes. The tool assembly and process of the present invention is especially useful in preparing a fixed glass such as a windshield for installation on a vehicle.

According to the principles of the present invention and in accordance with the described embodiments, the invention provides a tool assembly for automatically preparing a part prior to the part being assembled onto a vehicle. The tool assembly and the part are movable relative to each other. The tool assembly includes a plasma treatment device operable to direct a plasma on a surface of the part and a liquid dispensing module mounted adjacent the plasma treatment device and operable to dispense a liquid onto a plasma treated surface prior to the part being assembled onto the vehicle.

These and other objects and advantages of the present invention will become more readily apparent during the following detailed description taken in conjunction with the drawings herein.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a schematic diagram illustrating a first embodiment of a tool assembly with a plasma treatment device and a liquid dispensing module mounted thereon in accordance with the principles of the present invention.

FIG. 2 is a schematic diagram illustrating another embodiment of a tool assembly with a plasma treatment device and a liquid dispensing module mounted thereon in accordance with the principles of the present invention.

FIG. 3 is a schematic diagram illustrating a further embodiment of a tool assembly with a plasma treatment device and a liquid dispensing module mounted thereon in accordance with the principles of the present invention.

FIG. 4 is a schematic diagram illustrating an embodiment providing a first tool assembly with a plasma treatment device mounted thereon and a second tool assembly with a dispensing module mounted thereon in accordance with the principles of the present invention.

### DETAILED DESCRIPTION OF THE INVENTION

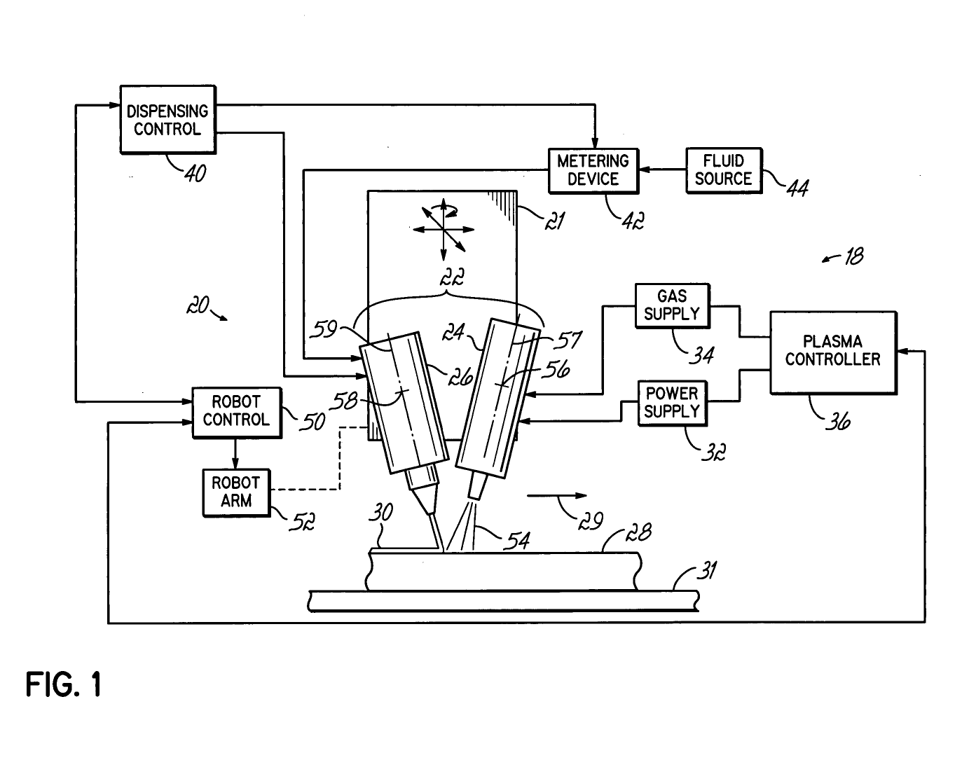

Referring to FIG. 1, a single assembly line workstation 18 has a tool positioning device 20, for example, a tool mounting plate 21, mechanically connected to a robot arm 52 that is operated by a robot control 50. A suitable industrial robot arm is commercially available from Fanuc, Kuka, ABB, etc. The robot arm may be any type employed in the assembly of automobiles or other vehicles. Attached to the end of the robot arm 20 is a tool assembly 22, which includes a plasma treatment device 24 and a liquid dispensing module 26. The tool assembly 22 is located above a part 28 to be assembled onto a vehicle. The part 28 may be a glass part such as a windshield, rear glass, side glass, light lens, other glass part, or another vehicle part that is made from a ceramic, a polymer or metal and has a surface that can be activated by a plasma treatment process. In the description to follow, the part 28 will be referred to as a windshield, but as indicated above, other parts can be similarly treated. The windshield 28 is supported by a work support 31, for example, a part fixture that, in turn, is supported by a table, a conveyor or another robot arm. In this application, the robot arm 20 is operable to move the tool assembly 22 in the direction of the arrow 29, that is, to the right as viewed in FIG. 1. The tool assembly 22 is effective to simultaneously clean the windshield 28 and then, immediately dispense an adhesive/sealant 30 thereon. The tool assembly 22 can be used with other fixed glass parts used in the assembly of vehicles. The plasma treatment device 24 plasma treats a surface at a marginal edge of the windshield 28 immediately in front of an adhesive/sealant 30 being dispensed by dispensing module 26.

The plasma treatment device 24 is connected to a power supply 32 and gas supply 34 that, in turn, are operated by a plasma controller 36. The plasma treatment device 24 provides an atmospheric plasma, which is highly charged ionized air that reacts with microscopic particles on the surface of the windshield 28. That reaction changes the microscopic particle chemistry from a solid to a gas, and the force of the gas carries the newly formed particles away. Additionally, the charged/ionized gas provides a surface activation of the glass where the surface energy of the solid is increased. Thus, the plasma treatment process cleans and activates the surface to promote adhesion of the adhesive/sealant. A plasma treatment device suitable for this application is commercially available from Surfx Technologies, LLC of Culver City, Calif.

Dispensing module 26 is operated by a dispensing control 40 that controls the operation of a metering device 42, for example, gear pump, a metering pump, a shot meter, a doser, etc., to provide the adhesive/sealant from a fluid source 44 to the dispensing module 26. The adhesive/sealant is dispensed from the dispensing module 26 onto the plasma treated surface of the windshield 28. The dispensing module 26 can be implemented using an automatic dispensing module commercially available from Nordson Corporation of Westlake, Ohio.

In use, the robot control 50 provides command signals to the robot arm 52 to move the tooling assembly 22 along the marginal edge of the windshield 28. The robot control 50 provides further command signals to the plasma controller 36 and dispensing control 40. The plasma controller 36 activates the plasma treatment device 24 to direct a plasma 54 onto the windshield 28, thereby cleaning and activating a surface at the marginal edge of the windshield 28. Simultaneously, the robot control 50 commands the dispensing control 40 to open the dispensing module 26 to initiate dispensing of the adhesive/sealant 30. As shown in FIG. 1, the adhesive/sealant 30 is dispensed immediately behind the plasma 54, so that the cleaned surface is immediately coated with the adhesive/sealant 30. Hence, the plasma treatment process does not require any delay in the application of the adhesive/sealant 30; and after application of the adhesive/sealant, the windshield 28 can be assembled on a vehicle. If the work support 31 is part of a robot arm, that robot arm can be used to position the windshield 28 during plasma treatment and application of the adhesive/sealant and thereafter, reposition the windshield 28 to assemble it on a vehicle.

The plasma treatment device 24 is mounted on the robot arm 20, so that it is rotatable about an axis 56 substantially perpendicular to a longitudinal centerline 57; and the dispensing module 26 is mounted on the robot arm 20 to be rotatable about an axis 58 substantially perpendicular to a longitudinal centerline 59. Therefore, depending on the type of adhesive/sealant used and other application parameters, the orientation of the plasma treatment device 24 and dispensing module 26 can be adjusted to control the application of the plasma and adhesive/sealant, respectively. For example, the plasma 54 can be directed onto an area of the part 28 either overlapping or intersecting with, or separated from, the simultaneous application of the adhesive/sealant 30.

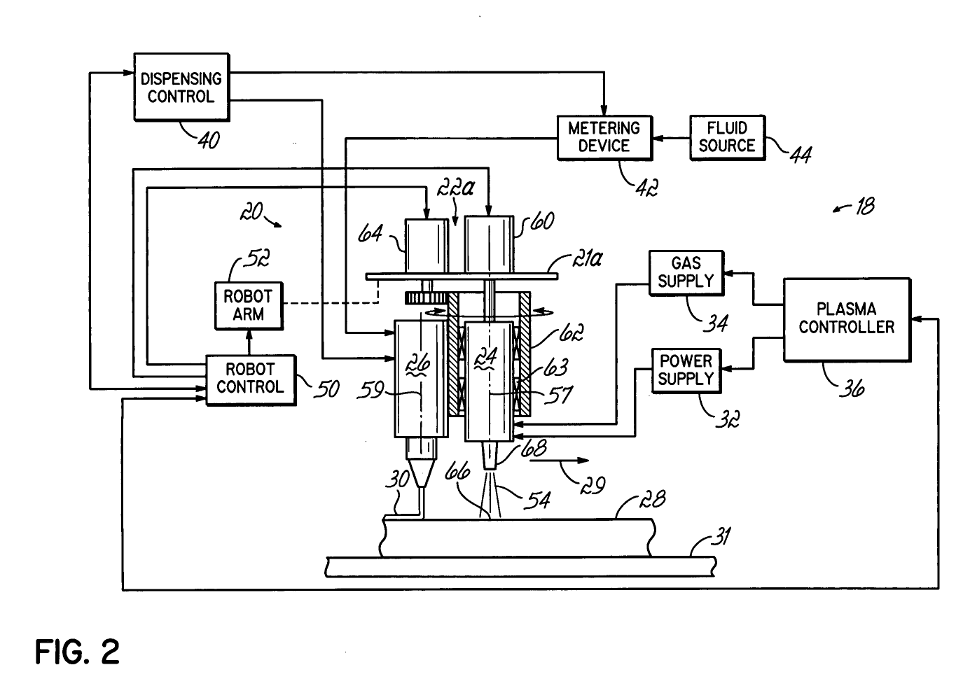

In other applications it may be desirable for the plasma treatment device 24 and dispensing module 26 to have other independent motions. Referring to FIG. 2, the single assembly line workstation 18 has a tool positioning device 20 with a different tool mounting plate 21 to accommodate a different configuration of the tool assembly 22a. In this embodiment, the plasma treatment device 24 is connected to an actuator 60, for example, an electric or fluid motor, which is effective to rotate the plasma treatment device 24 within a cylinder 62 about an axis defined by its longitudinal centerline 57. The cylinder 62 supports the dispensing module 26 and is connected to an actuator 64, such as an electric or fluid motor. The actuator 64 provides an independent arcuate motion of the dispensing module 26 by moving or swinging its longitudinal centerline 59 in a circular path about the axis 57. Bearings 63 maintain the rotations of the plasma treatment device 24 and the cylinder 62 coaxial with respect to a programmable tool center point 66. The configuration of the tool assembly 22a permits a separation between the plasma 54 and the adhesive/sealant 30. In addition, the tool assembly 22a allows the dispensing module 26 to more closely track the path of the plasma treatment device 24 around corners.

If a nozzle 68 of the plasma treatment device 24 is circular, then the plasma treatment device 24 provides a uniform cleaning pattern regardless of the linear direction in which the plasma treatment device is moved; and the actuator 60 is not used. However, if the nozzle of the plasma treatment device is elliptical or other noncircular shape, in order to maintain a uniform cleaning pattern as the plasma treatment device 24 is moved in different directions, the plasma treatment device 24 will have to be rotated by the actuator 60.

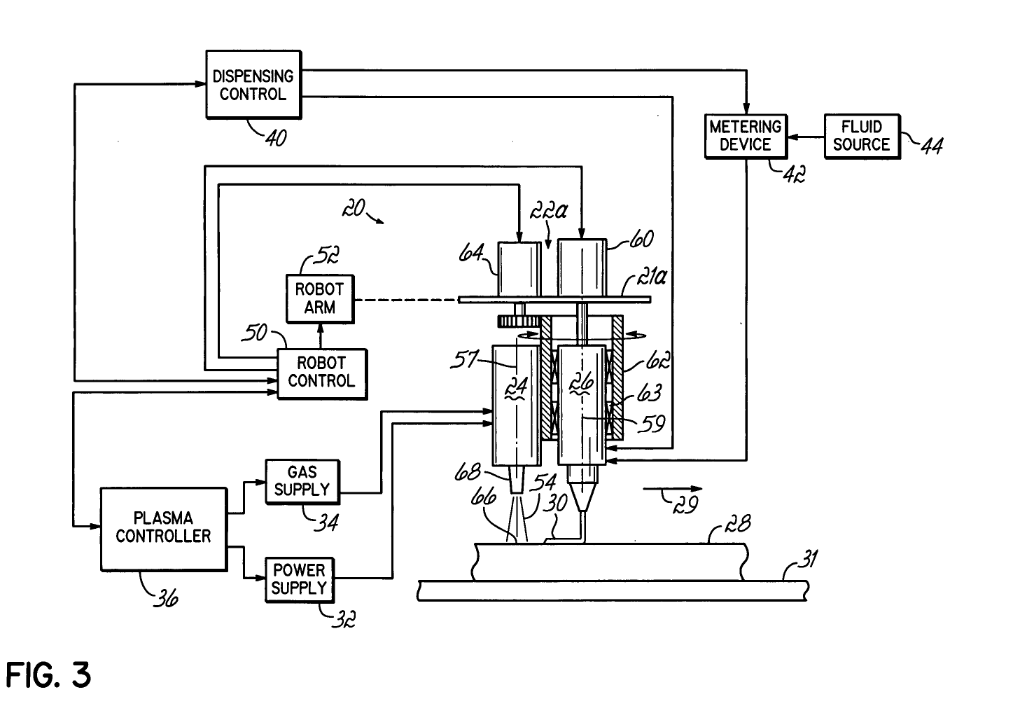

In an alternative embodiment, referring to FIG. 3, the mountings of the plasma treatment device 24 and the dispensing module 26 are reversed. In this embodiment, the dispensing module 26 is connected to, and operated by, the actuator 60; and the plasma treatment device is connected to, and operated by, the actuator 64. Thus, the dispensing module 26 rotates about the axis 59; and the plasma treatment module 24 swings or moves in a circular arc about the axis 59 and the dispensing module 26. Such a relationship may prove beneficial to maintain a triangular shape of a bead profile. In FIGS. 2 and 3, the actuators 60, 64 are operated by the robot control 50; but in other embodiments, the actuators 60, 64 can be connected to, and operated by, other controls.

In summary, in just a single pass around the glass, the tool assemblies 22, 22a are operative to clean the glass and immediately apply an adhesive/sealing agent to the glass. Thus, the tool assemblies 22, 22a have the advantage of cleaning and dispensing adhesive/sealant at a single assembly line workstation. This is a substantial improvement over existing processes requiring a priming workstation and a downstream adhesive dispensing workstation. The tool assemblies 22, 22a have a further advantage of eliminating the chemicals that have previously been used to prime glass for assembly into a vehicle. Thus, the tool assemblies 22, 22a are able to prepare glass for installation into a vehicle in much less time, at much less cost and in less manufacturing floor space than known processes.

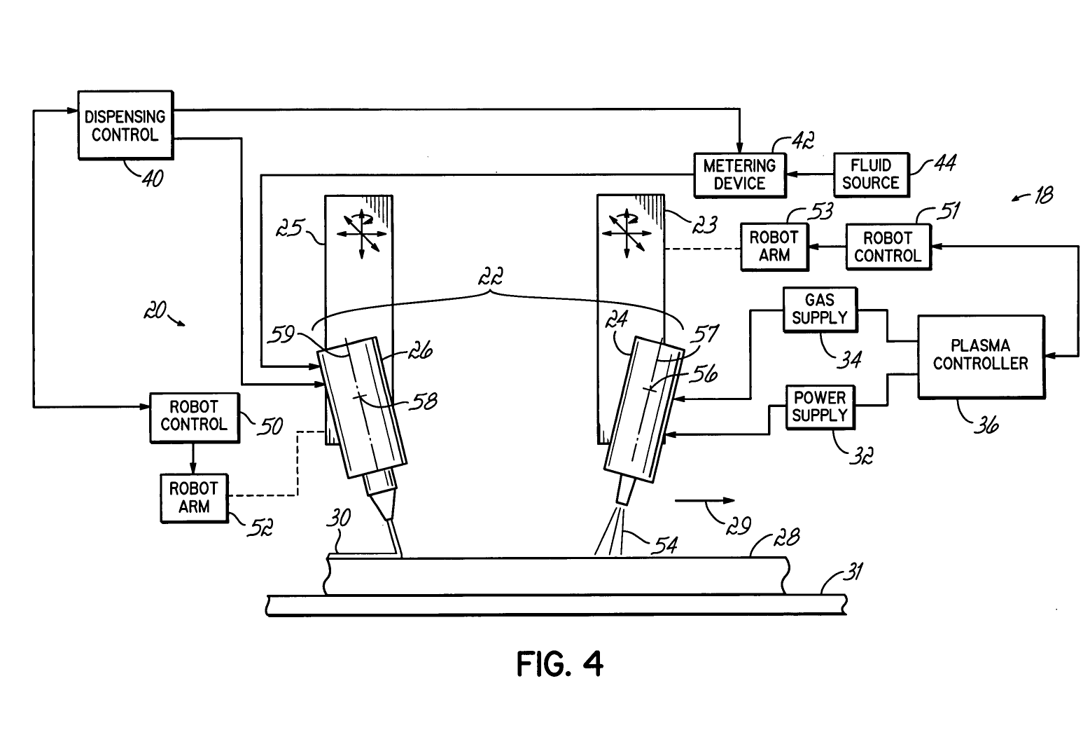

In the described embodiments of FIGS. 1-3, the plasma treatment device 24 and dispensing module 26 are mounted on a common tool mounting plate 21 movable by a single positioning device 20. Referring to FIG. 4, in an alternative embodiment, the plasma treatment device 24 is mounted to a first tool mounting plate 23; and the dispensing module is mounted to a second tool mounting plate 25. The first and second tool mounting plates are movable by first and second robot arms 52, 53. Thus, the plasma treatment process is separated in space and time from the dispensing of the adhesive/sealant; however, the greater the separation, the more the plasma treated surface is subject to contamination. The first robot arm 52 is operated by a first robot control 51 that is also in electrical communications with the dispensing control 40. The second robot arm 52 is operated by a second robot control 53 that is also in electrical communications with the plasma controller 36. The first and second robot controls 50, 51 can also be in electrical communications with each other or one or more system controls in a known manner. Thus, in this application, the control of the position and orientation of the plasma treatment device 24 is totally independent of the control of the position and orientation of the dispensing module 26. In operation, the robot control 51 commands the robot arm 53 to move the plasma treatment device 24 relative to the windshield 28; and simultaneously, the plasma controller 36 causes the plasma treatment device 24 to direct a plasma on a surface of the windshield to create a plasma treated surface. The robot control 50 commands the robot arm 52 to move the dispensing module 26 relative to the windshield 28; and the dispensing control 40 simultaneously causes the dispensing module to dispense an adhesive/sealant onto the plasma treated surface.

While the present invention has been illustrated by a description of an embodiment, and while such embodiment has been described in considerable detail, there is no intention to restrict, or in any way limit, the scope of the appended claims to such detail. Additional advantages and modifications will readily appear to those skilled in the art. For example, in the described embodiment, the windshield 28 is held stationary; and the robot arm 20 is operable to move the tool assembly 22 relative to the stationary windshield 28. However, in an alternative embodiment, the tool assembly 22 can be held stationary; and the windshield 28 moved by a robot arm or other positioning device. In a still further embodiment, the tool assembly 22 and windshield 28 can be moved by independent respective positioning devices.

Further, in the described embodiments of FIGS. 1-3, the dispensing module 26 is operated simultaneously with the plasma treatment device 24 while the robot arm 52 is moving them along a path of motion. In an alternative embodiment, the plasma treatment device 24 can be operated first while the robot arm 52 is moving along a first path of motion; and thereafter, the dispensing module 26 is operated while the robot arm 52 is moving through a subsequent path of motion. The paths of motion may be different, similar or identical depending on the structure of the plasma treatment device 24 and the dispensing module 26 and other application related parameters.

Therefore, the invention in its broadest aspects is not limited to the specific details shown and described. Consequently, departures may be made from the details described herein without departing from the spirit and scope of the claims which follow.

What is claimed is:

1. A tool assembly for automatically preparing a part prior to the part being assembled onto a vehicle, the tool assembly and the part being movable relative to each other in a first direction and the tool assembly comprising:
a plasma treatment device operable to direct a plasma on a surface of the part and provide a plasma treated surface on the part; and
a liquid dispensing module mounted adjacent the plasma treatment device and adapted to be operable to dispense an adhesive/sealant onto the plasma treated surface prior to the part being assembled onto the vehicle.

2. The tool assembly of claim 1 wherein the plasma treatment device and the liquid dispensing module are mounted on the tool assembly such that the plasma is directed to an area of the surface of the part prior to the adhesive/sealant being dispensed on the area of the surface of the part.

3. The tool assembly of claim 1 wherein the plasma treatment device and the liquid dispensing module are mounted on the tool assembly such that the plasma is directed to an area of the surface of the part substantially simultaneously with the adhesive/sealant being dispensed on the area of the surface of the part.

4. The tool assembly of claim 1 wherein the plasma treatment device is mounted on the tool assembly to be movable with respect to the tool assembly.

5. The tool assembly of claim 1 wherein the plasma treatment device is mounted on the tool assembly to rotate with respect to an axis substantially perpendicular to a longitudinal centerline of the plasma treatment device.

6. The tool assembly of claim 1 wherein the plasma treatment device is mounted on the tool assembly to rotate with respect to an axis substantially parallel to a longitudinal centerline of the plasma treatment device.

7. The tool assembly of claim 6 wherein the liquid dispensing module is mounted on the tool assembly to move in a circular path with respect to the longitudinal centerline of the plasma treatment device.

8. The tool assembly of claim 1 wherein the dispensing module is mounted on the tool assembly to be movable with respect to the tool assembly.

9. The tool assembly of claim 1 wherein the liquid dispensing module is mounted on the tool assembly to rotate with respect to an axis substantially perpendicular to a longitudinal centerline of the liquid dispensing module.

10. The tool assembly of claim 1 wherein the liquid dispensing module is mounted on the tool assembly to rotate with respect to an axis substantially parallel to a longitudinal centerline of the liquid dispensing module.

11. The tool assembly of claim 6 wherein the plasma treatment device is mounted on the tool assembly to move in a circular path with respect to the longitudinal centerline of the liquid dispensing module.

12. An apparatus for preparing glass prior to the glass being assembled onto a vehicle, the apparatus comprising:
a plasma treatment device;
a first positioning device supporting the plasma treatment device, the first positioning device being operable to provide first relative motion between the plasma treatment device and the glass to direct a plasma on a surface of the glass during the first relative motion and provide a plasma treated surface on the glass;
a liquid dispensing module; and
a second positioning device supporting the liquid dispensing module, the second positioning device being operable to provide second relative motion between the liquid dispensing module and the glass to dispense an adhesive/sealant onto the plasma treated surface during the second relative motion.

13. An apparatus for preparing glass prior to the glass being assembled onto a vehicle, the apparatus comprising:
a tool assembly comprising
a plasma treatment device, and
a liquid dispensing module mounted adjacent the plasma treatment device;
a positioning device supporting the tool assembly; and
a control in communications with the plasma treatment device, the dispensing module and the positioning device, the control operating the positioning device, the plasma treatment device and the dispensing module to produce relative motion between the glass and the tool assembly while directing a plasma on a surface of the glass and then, dispensing an adhesive/sealant onto the surface of the glass.

14. The apparatus of claim 13 wherein the plasma treatment device is mounted on the tool assembly to be movable with respect to the tool assembly.

15. The apparatus of claim 13 wherein the dispensing module is mounted on the tool assembly to be movable with respect to the tool assembly.

16. The apparatus of claim 13 wherein each of the plasma treatment device and the dispensing module is mounted on the tool assembly to be independently movable with respect to the tool assembly.

17. A method of preparing a part for assembly onto a vehicle, the method comprising:
providing relative motion between the part and a tool assembly having a plasma treatment device and a liquid dispensing module mounted thereon;
plasma treating a surface of the part with the plasma treatment device in response to the relative motion to provide a plasma treated surface on the part; and
thereafter, dispensing an adhesive/sealant onto the plasma treated surface with the liquid dispensing module.

18. The method of claim 17 further comprising assembling the part with the adhesive/sealant on the plasma treated surface on the vehicle.

19. The method of claim 17 further comprising dispensing the adhesive/sealant such that the adhesive/sealant does not intersect with the plasma.

20. The method of claim 17 further comprising dispensing the adhesive/sealant such that the adhesive/sealant intersects with the plasma.

21. A method of preparing a part for assembly onto a vehicle, the method comprising:
providing automatically a first relative motion between the part and a plasma treatment device;
plasma treating a surface of the part with the plasma treatment device during the first relative motion to provide a plasma treated surface on the part;
providing automatically a second relative motion between the part and a liquid dispensing module; and
dispensing an adhesive/sealant onto the plasma treated surface with the liquid dispensing module during the second relative motion.

22. The method of claim 21 further comprising assembling the part with the adhesive/sealant on the plasma treated surface on the vehicle.

23. A method of preparing glass for assembly onto a vehicle, the method comprising:
providing relative motion between a tool assembly and the glass along a path generally following a marginal edge of the glass;
plasma treating a surface of the glass with a plasma treating device mounted on the tool assembly in response to the relative motion to provide a plasma treated surface along the marginal edge of the glass; and
dispensing an adhesive/sealant onto the plasma treated surface with an adhesive/sealant dispensing module mounted on the tool assembly in response to the relative motion between the tool assembly and the glass prior to the glass being assembled onto the vehicle.

24. The method of claim 23 further comprising assembling the glass with the adhesive/sealant on the plasma treated surface on the vehicle.

25. A method of preparing a windshield for assembly onto a vehicle, the method comprising:
automatically plasma treating an edge surface of the windshield with a plasma treatment device to provide a plasma treated edge surface of the windshield; and
thereafter, automatically dispensing an adhesive/sealant onto the plasma treated edge surface of the windshield with a liquid dispensing module.

26. The method of claim 25 further comprising assembling the windshield with the adhesive/sealant on the plasma treated edge surface onto the vehicle.

27. The method of claim 25 further comprising plasma treating a small portion of the edge surface of the windshield prior to dispensing the adhesive/sealant onto the plasma treated edge surface.

28. The method of claim 25 further comprising plasma treating a substantial portion of the edge surface of the windshield prior to dispensing the adhesive/sealant onto the plasma treated edge surface.

29. The method of claim 25 wherein the plasma treatment device and the liquid dispensing module are mounted on respective first and second independently operable positioning devices.

30. The method of claim 25 wherein plasma treating the edge portion of the windshield and dispensing the adhesive onto the plasma treated edge surface of the windshield are performed substantially simultaneously.

31. A method of preparing glass for assembly onto a vehicle, the method comprising:
plasma treating an edge surface of the glass with a plasma treating device mounted on a tool assembly to provide a plasma treated surface along the edge surface of the glass; and
dispensing an adhesive/sealant onto the plasma treated surface with an adhesive/sealant dispensing module mounted on the tool assembly prior to the glass being assembled onto the vehicle.

32. The method of claim 31 further comprising assembling the glass with the adhesive/sealant on the plasma treated surface onto the vehicle.

33. The method of claim 31 wherein plasma treating of the edge surface of the glass and dispensing of the adhesive onto the plasma treated surface are performed substantially simultaneously.
